(19) United States
(12) Patent Application Publication
(10) Pub. No.: US 2011/0029151 A1
(43) Pub. Date: Feb. 3, 2011

(54) TEMPERATURE ADJUSTMENT SYSTEM AND METHOD FOR A STORAGE SYSTEM

(75) Inventors: CHIANG-CHUNG TANG, Tu-Cheng (TW); WEI LIAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/826,709

(22) Filed: Jun. 30, 2010

(30) Foreign Application Priority Data
Jul. 30, 2009 (CN) 200910305041.0

(51) Int. Cl. G05D 23/19; G05D 13/00

(52) U.S. Cl. 700/300; 700/304

(57) ABSTRACT

In a temperature adjustment system and method for a storage system, a corresponding relationship between data transfer rates of the storage system and rotational speeds of electric fans coupled to the storage system is established. Real-time data transfer rates of the storage system are measured. If there is a continuous increase or decrease in data transfer rates of the storage system, a rotational speed of the electric fans is determined according to the real-time data transfer rates and the corresponding relationship. The electric fans are controlled to run at the determined rotational speed.

### BACKGROUND

1. Technical Field

Embodiments of the present disclosure relate to temperature adjustment systems and methods, and particularly to a temperature adjustment system and method for a storage system.

2. Description of Related Art

Storage systems usually generate a lot of heat while working. Overheating of the storage systems may lead to data loss or even damage to the storages devices. Currently, temperature sensors and electric fans are coupled to storage systems for heat dispersion. The temperature sensors measure the temperature of the storage systems, while the electric fans are controlled to run at different rotational speeds. However, changes in data transfer rates of the storage systems cause changes in the temperature of the storage systems. With current temperature adjustment methods, the temperature of the storage systems may change frequently.

### BRIEF DESCRIPTION OF THE DRAWINGS

FIG. 1 is a block diagram of one embodiment of a storage area network (SAN) including a temperature adjustment system and a storage system.

FIG. 2 is a block diagram of one embodiment of a temperature adjustment unit in FIG. 1.

FIG. 3 is a flowchart of one embodiment of a temperature adjustment method for a storage system implementing a temperature adjustment system, such as that in FIG. 1.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage system.

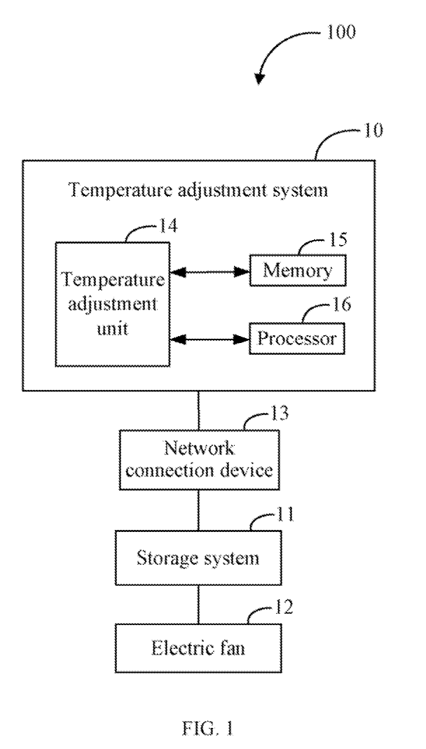

FIG. 1 is a block diagram of one embodiment of a storage area network (SAN) 100 including a temperature adjustment system 10 and a storage system 11. The temperature adjustment system 10 controls the rotational speed of at least one electric fan 12 (only one shown in FIG. 1) coupled to the storage system 11, to keep the storage system 11 within a specified temperature range. In the SAN 100, the temperature adjustment system 10 may be connected to the storage system 11 via a network connection device 13, such as a hub, a router, or a switch. The storage system 11 includes storage devices such as hard disk drives, optical drives, and/or tape drives. The temperature adjustment system 10 may be a data processing device or a computerized device, such as a personal computer, an application server, or a workstation, for example.

In one embodiment, the temperature adjustment system 10 may include a temperature adjustment unit 14, a memory 15, and at least one processor 16. One or more computerized codes of the temperature adjustment unit 14 may be stored in the memory 15 and executed by the at least one processor 16.

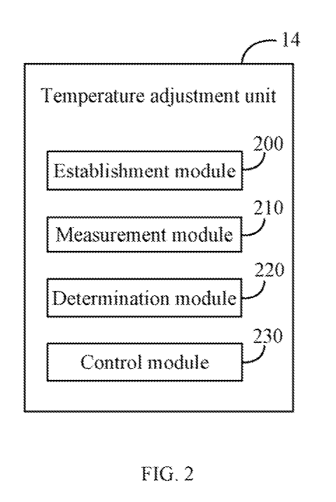

FIG. 2 is a block diagram of one embodiment of the temperature adjustment unit 14 in FIG. 1. In one embodiment, the temperature adjustment unit 20 may include an establishment module 200, a measurement module 210, a determination module 220, and a control module 230.

The establishment module 200 establishes a corresponding relationship between data transfer rates of the storage system 11 and rotational speeds of the electric fan 12. According to the corresponding relationship, each of the data transfer rates of the storage system 11 may correspond to one of the rotational speeds of the electric fan 12. For example, if a data transfer rate of the storage system 11 is 100 MB/s, a corresponding rotational speed of the electric fan 12 is 2000 revolutions per minute (RPM). If a data transfer rate of the storage system 11 is 160 MB/s, a corresponding rotational speed of the electric fan 12 is 2400 RPM.

The measurement module 210 measures real-time data transfer rates of the storage system 11. The measurement module 210 may measure the real-time data transfer rates of the storage system 11 at a predetermined time interval, such as every 30 seconds. In one example, the measurement module 210 measures three real-time data transfer rates of 120 MB/s, 140 MB/s and 160 MB/s.

The determination module 220 determines whether there is a continuous increase or decrease in data transfer rates of the storage system 11 according to the real-time data transfer rates. In one example, the measurement module 210 measures three real-time data transfer rates. In addition, the determination module 220 determines if there is a continuous increase or decrease in data transfer rates of the storage system 11 according to the three real-time data transfer rates. For example, three real-time data transfer rates D1, D2, and D3 are obtained. If D1<D2<D3, there is the continuous increase in data transfer rates of the storage system 11. If D1>D2>D3, there is the continuous decrease in data transfer rates of the storage system 11.

The control module 230 determines a rotational speed of the electric fan 12 according to the real-time data transfer rates and the corresponding relationship. In one embodiment, the control module 230 may calculate a mean value of the real-time data transfer rates. The control module 230 determines a rotational speed of the electric fan 12 according to the corresponding relationship. In addition, the control module 230 controls the electric fan 12 to run at the determined rotational speed.

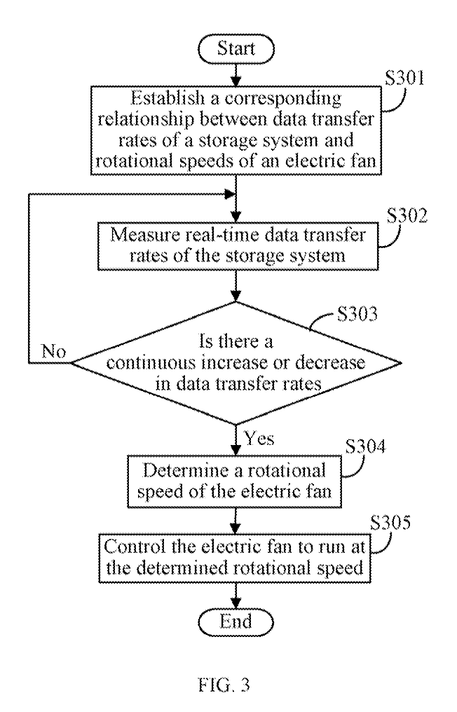

FIG. 3 is a flowchart of one embodiment of a temperature adjustment method for a storage system (e.g., the storage system 11) implementing a temperature adjustment system, such as that in FIG. 1. The method may be used to control the rotational speed of at least one electric fan 12 coupled to the storage system 11, so that the storage system 11 is kept within a specified temperature range. Depending on the embodiments, additional blocks may be added, others removed, and the ordering of the blocks may be changed.

In block S301, the establishment module 200 establishes a corresponding relationship between data transfer rates of the storage system 11 and rotational speeds of the electric fan 12. According to the corresponding relationship, each of the data transfer rates of the storage system 11 may correspond to one of the rotational speeds of the electric fan 12. For example, if a data transfer rate of the storage system 11 is 100 MB/s, a corresponding rotational speed of the electric fan 12 is 2000 RPM. If a data transfer rate of the storage system 11 is 140 MB/s, a corresponding rotational speed of the electric fan 12 is 2400 RPM.

In block S302, the measurement module 210 measures real-time data transfer rates of the storage system 11. In one embodiment, the measurement module 210 measures three real-time data transfer rates of the storage system 11 at a predetermined time interval. For example, the measurement module 210 measures three real-time data transfer rates of 120 MB/s, 140 MB/s and 160 MB/s.

In block S303, the determination module 220 determines whether there is a continuous increase or decrease in data transfer rates of the storage system 11 according to the real-time data transfer rates. In one embodiment, the determination module 220 determines if there is the continuous increase or decrease in data transfer rates of the storage system 11 according to the three real-time data transfer rates measured by the measurement module 210. In one example, three real-time data transfer rates D1, D2, and D3 are measured. If D1<D2<D3, there is the continuous increase in data transfer rates of the storage system 11. If D1>D2>D3, there is the continuous decrease in data transfer rates of the storage system 11. For example, if the measurement module 210 measures three real-time data transfer rates of 120 MB/s, 140 MB/s and 160 MB/s, there is the continuous increase in data transfer rates of the storage system 11.

If there is no continuous increase or decrease in data transfer rates of the storage system 11, the process returns to block S302.

Otherwise, if there is the continuous increase or decrease in data transfer rates of the storage system 11, in block S304, the control module 230 determines a rotational speed of the electric fan 12 according to the real-time data transfer rates and the corresponding relationship. In one embodiment, the control module 230 may calculate a mean value of the real-time data transfer rates. The control module 230 determines a rotational speed of the electric fan 12 according to the mean value and the corresponding relationship.

In one example, three real-time data transfer rates of 120 MB/s, 140 MB/s and 160 MB/s are measured. A mean value of the three real-time data transfer rates is 140 MB/s. The control module 230 determines a rotational speed of 2400 RPM corresponding to the mean value 140 MB/s according to the corresponding relationship. Depending on the embodiment, the rotational speed of the electric fan 12 may be determined according to one of the real-time data transfer rates (e.g., the last one) and the corresponding relationship.

In block S305, the control module 230 controls the electric fan 12 to run at the determined rotational speed. In one example, the control module 230 sends a rotational speed control command to the electric fan 12. In response to the rotational speed control command, the electric fan 12 runs at the determined rotational speed.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A temperature adjustment system for a storage system, the storage system coupled to at least one electric fan, the temperature adjustment system comprising:
a memory;
one or more processors; and
a temperature adjustment unit being stored in the memory and executed by the one or more processors, the temperature adjustment unit comprising:
an establishment module operable to establish a corresponding relationship between data transfer rates of the storage system and rotational speeds of the at least one electric fan;
a measurement module operable to measure real-time data transfer rates of the storage system;
a determination module operable to determine if there is a continuous increase or decrease in data transfer rates of the storage system according to the real-time data transfer rates, and determine a rotational speed of the at least one electric fan according to the real-time data transfer rates and the corresponding relationship upon the condition that the real-time data transfer rates increase or decrease continually; and
a control module operable to control the at least one electric fan to run at the determined rotational speed.

2. The temperature adjustment system of claim 1, wherein the storage system comprises one or more hard disk drives, optical drives, and/or tape drives.

3. The temperature adjustment system of claim 1, wherein the temperature adjustment system is applied in a storage area network.

4. The temperature adjustment system of claim 1, wherein the measurement module measures three real-time data transfer rates of the storage system at a predetermined time interval.

5. The temperature adjustment system of claim 4, wherein the determination module determines if there is the continuous increase or decrease in data transfer rates of the storage system according to the three real-time data transfer rates, and determines the rotational speed of the at least one electric fan according to the three real-time data transfer rates and the corresponding relationship.

6. A temperature adjustment method for a storage system, the storage system coupled to at least one electric fan, the method comprising:
(a) establishing a corresponding relationship between data transfer rates of the storage system and rotational speeds of the at least one electric fan;
(b) measuring real-time data transfer rates of the storage system;
(c) determining if there is a continuous increase or decrease in data transfer rates of the storage system according to the real-time data transfer rates;
(d) determining a rotational speed of the at least one electric fan according to the real-time data transfer rates and the corresponding relationship upon condition that the real-time data transfer rates increase or decrease continually; and
(e) controlling the at least one electric fan to run at the determined rotational speed.

7. The method of claim 6, wherein the storage system comprises one or more hard disk drives, optical drives, and/or tape drives.

8. The method of claim 6, wherein the method is applied in a storage area network.

9. The method of claim 6, wherein in block (b) three real-time data transfer rates of the storage system are measured at a predetermined time interval.

10. The method of claim 9, wherein in block (c) the continuous increase or decrease in data transfer rates of the storage system is determined according to the three real-time data transfer rates, and in block (d) the rotational speed of the at least one electric fan is determined according to the three real-time data transfer rates and the corresponding relationship.

11. A computer-readable medium having stored thereon instructions that, when executed by a computerized device, cause the computerized device to execute a temperature adjustment method for a storage system coupled to at least one electric fan, the method comprising:
(a) establishing a corresponding relationship between data transfer rates of the storage system and rotational speeds of the at least one electric fan;
(b) measuring real-time data transfer rates of the storage system;
(c) determining if there is a continuous increase or decrease in data transfer rates of the storage system according to the real-time data transfer rates;
(d) determining a rotational speed of the at least one electric fan according to the real-time data transfer rates and the corresponding relationship upon condition that the real-time data transfer rates increase or decrease continually; and
(e) controlling the at least one electric fan to run at the determined rotational speed.

12. The computer-readable medium of claim 11, wherein the storage system comprises one or more hard disk drives, optical drives, and/or tape drives.

13. The computer-readable medium of claim 11, wherein the method is applied to a storage area network.

14. The computer-readable medium of claim 11, wherein in block (b) three real-time data transfer rates of the storage system are measured at a predetermined time interval.

15. The computer-readable medium of claim 14, wherein in block (c) the continuous increase or decrease in data transfer rates of the storage system is determined according to the three real-time data transfer rates, and in block (d) the rotational speed of the at least one electric fan is determined according to the three real-time data transfer rates and the corresponding relationship.
